(19) United States
(12) Patent Application Publication
(10) Pub. No.: US 2026/0273770 A1
(43) Pub. Date: Sep. 17, 2026

(54) UNLOADING ASSEMBLY

(71) Applicant: Bear Robotics, Inc., Redwood City, CA (US)

(72) Inventor: Gino NGUEGANG, Redwood City, CA (US)

(73) Assignee: Bear Robotics, Inc., Redwood City, CA (US)

(21) Appl. No.: 19/473,347

(22) PCT Filed: Apr. 12, 2023
(86) PCT No.: PCT/US2023/018278

§ 371 Date: Oct. 7, 2025

(51) Int. Cl. B25J 11/00; B25J 15/00

(52) U.S. Cl. CPC B25J 11/008; B25J 11/0045; B25J 15/0014

(57) ABSTRACT

According to one aspect of the present invention, there is provided an unloading assembly for unloading a tray, comprising: a main body unit having a left side and a right side on each of which a first guide groove is formed, and a bottom side removably attached to a predetermined position; a support unit having a support member formed in an inward direction of the main body unit to support a tray, and configured to perform a primary linear motion along the first guide groove in a frontward direction of the main body unit, wherein a second guide groove is formed along at least a part of the support member; and a push unit configured to perform a secondary linear motion along the second guide groove in the frontward direction of the main body unit to cause the tray to be unloaded onto a target structure.

### FIELD OF THE INVENTION

The present invention relates to an unloading assembly.

### BACKGROUND

With the development of robot technology, service robots as well as industrial robots are attracting more attention and demand. The service robots are being applied to various fields of daily life, and among these service robots, autonomously driving serving robots for transporting food ordered by a customer to a table in a restaurant or the like are also known. The serving robots are receiving rapidly increasing attention due to their advantages of maximizing the efficiency of restaurant management and improving the quality of customer service.

FIG. 1 illustratively shows a robot for serving food and/or drinks. Referring to FIG. 1, a robot 10 comprises a drive unit 11 for moving the robot 10 and a main body unit 12 mounted on an upper end of the drive unit 11. The main body unit 12 may be provided with a device to which a user's command may be inputted or a device which may receive a user's command through wireless communication, and may autonomously drive to serve food and/or drinks to a customer or collect containers of the food and/or drinks after the customer finishes eating, according to the inputted or received command. Further, a tray for serving food and/or drinks or collecting containers may be disposed at the main body unit 12.

However, when the robot configured as above transports the tray to a table where the customer is located, the customer should pick up the tray and place it on the table, or when the robot comes to the table in order to collect the tray, the customer should pick up the tray and place it at a suitable position on the robot. This leads to a limitation that human intervention is essential for the robot to achieve the purpose of serving or bussing.

### SUMMARY OF THE INVENTION

One object of the present invention is to solve all the above-described problems in the prior art.

Another object of the invention is to unload a tray onto a target structure while minimizing human intervention during the operation of a robot.

Yet another object of the invention is to unload a tray from a robot to a fixed structure, as well as unload (or load) a tray from a fixed structure to a robot.

The representative configuration of the invention to achieve the above objects is described below.

According to one aspect of the invention, there is provided an unloading assembly for unloading a tray, comprising: a main body unit having a left side and a right side on each of which a first guide groove is formed, and a bottom side removably attached to a predetermined position; a support unit having a support member formed in an inward direction of the main body unit to support a tray, and configured to perform a primary linear motion along the first guide groove in a frontward direction of the main body unit, wherein a second guide groove is formed along at least a part of the support member; and a push unit configured to perform a secondary linear motion along the second guide groove in the frontward direction of the main body unit to cause the tray to be unloaded onto a target structure.

In addition, there are further provided other unloading assemblies to implement the invention.

According to the invention, it is possible to unload a tray onto a target structure while minimizing human intervention during the operation of a robot.

According to the invention, it is possible to unload a tray from a robot to a fixed structure, as well as unload (or load) a tray from a fixed structure to a robot.

### BRIEF DESCRIPTION OF THE DRAWINGS

FIG. 1 illustratively shows a robot for serving food and/or drinks.

FIG. 2 shows an unloading assembly according to one embodiment of the invention.

FIG. 3 shows the internal configuration of the unloading assembly according to one embodiment of the invention.

FIG. 4 is a partially enlarged view of a stepped part of the unloading assembly according to one embodiment of the invention.

FIG. 5A illustratively shows an unloading process according to one embodiment of the invention.

FIG. 5B illustratively shows an unloading process according to one embodiment of the invention.

FIG. 6 is a bottom view of the unloading assembly according to one embodiment of the invention.

FIG. 7 illustratively shows a situation in which the unloading assembly according to one embodiment of the invention is disposed on a robot.

FIG. 8 illustratively shows a situation in which a target structure according to one embodiment of the invention is a fixed structure.

FIG. 9 illustratively shows a situation in which a target structure according to one embodiment of the invention is a mobile robot.

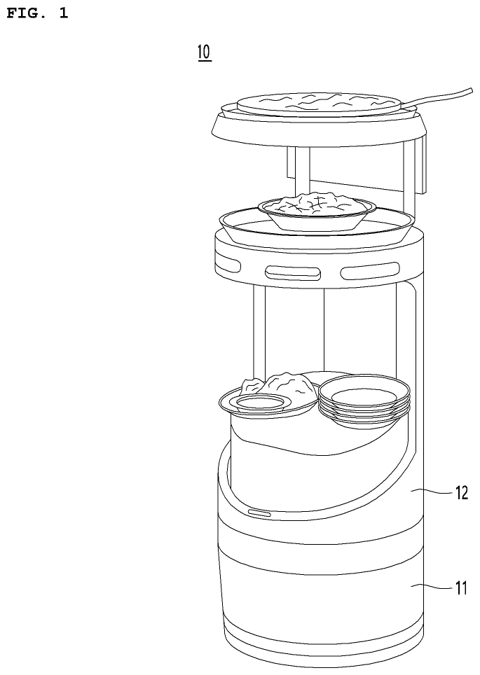

### DETAILED DESCRIPTION OF THE INVENTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the present invention will be described in detail with reference to the accompanying drawings to enable those skilled in the art to easily implement the invention.

### Structure of the Unloading Assembly

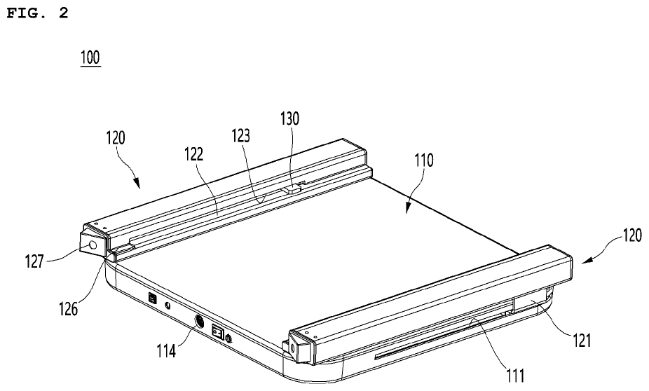

FIG. 2 shows an unloading assembly according to one embodiment of the invention.

Referring to FIG. 2, an unloading assembly 100 according to one embodiment of the invention may comprise a main body unit 110, a support unit 120, and a push unit 130.

First, the main body unit 110 according to one embodiment of the invention may be formed as a polyhedron such as a cube. For example, the main body unit 110 may be formed to have a front side, a rear side, a left side, a right side, a bottom side, and a top side, and may be formed with rounded corners on both sides such that the front, left, rear, and right sides appear to be connected.

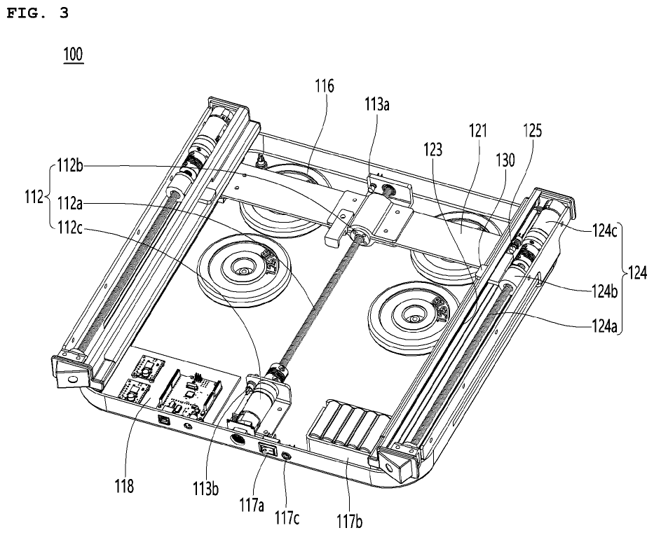

According to one embodiment of the invention, a first guide groove 111 may be formed on each of the left side and the right side of the main body unit 110. A connecting member 121 of the support unit 120 may be inserted into the first guide groove 111, and the connecting member 121 inserted into the first guide groove 111 may be coupled to a first slide member 112 located within the main body unit 110 (see FIG. 3). The first slide member 112 may comprise a screw shaft 112a and a nut 112b, and the connecting member 121 may be fixedly coupled to the nut 112b.

According to one embodiment of the invention, the first slide member 112 may have a motor 112c on one side, and the nut 112b and the connecting member 121 (or the support unit 120) coupled to the nut 112b may be moved in an axial direction of the screw shaft 112a by driving the motor 112c. Here, the movement of the nut 112b and the connecting member 121 (or the support unit 120) may be limited by a first distance detection sensor 113a, 113b located near one end of the screw shaft 112a. For example, the movement of the nut 112b and the connecting member 121 may be stopped when the first distance detection sensor 113a, 113b detects that the nut 112b and the connecting member 121 are located at a predetermined distance from the one end of the screw shaft 112a. In the process of movement as described above, the connecting member 121 (or the support unit 120) moves along the first guide groove 111, and the movement of the connecting member 121 (or the support unit 120) along the first guide groove 111 in a frontward direction of the main body unit 110 will be referred to as a primary linear motion.

Meanwhile, according to one embodiment of the invention, the support unit 120 may comprise a support member 122 configured to support a tray 200.

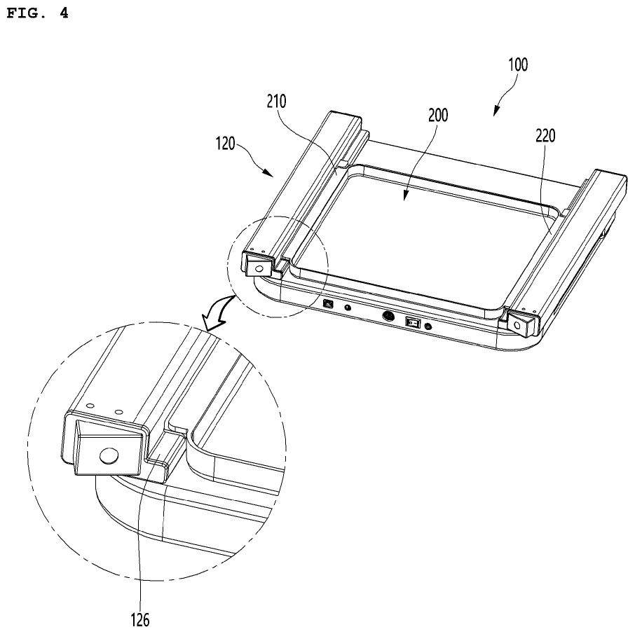

Specifically, the support unit 120 may be configured as a pair, and the pair of support units 120 may be disposed to face each other above the top side of the main body unit 110. That is, when viewing the support units 120 from the top of the unloading assembly 100, the support units 120 may appear to be disposed in the form of two parallel lines. A portion of each of the pair of support units 120 may be formed to protrude in an inward direction of the main body unit 110, and at least a part of the protruding portion may be configured as a support member 122. The support member 122 may support each of tabs 210 and 220 of the tray 200 (see FIGS. 2 and 4). In a state in which the support member 122 supports each of the tabs 210 and 220 of the tray 200, the top side of the main body unit 110 and the bottom side of the tray 200 may be spaced apart by a predetermined distance such that no friction is caused between them.

Meanwhile, according to one embodiment of the invention, a second guide groove 123 may be formed on a side of the support unit 120 that faces inwardly of the main body unit 110. The second guide groove 123 may be formed along at least a part of the support member 122, and its longitudinal direction may be parallel to that of the first guide groove 111.

According to one embodiment of the invention, the push unit 130 may be inserted into the second guide groove 123, and the push unit 130 inserted into the second guide groove 123 may be coupled to a second slide member 124 located within the support unit 120 (see FIG. 3). Like the first slide member 112, the second slide member 124 may comprise a screw shaft 124a and a nut 124b, and the push unit 130 may be fixedly coupled to the nut 124b.

According to one embodiment of the invention, the second slide member 124 may have a motor 124c on one side, and the nut 124b and the push unit 130 coupled to the nut 124b may be moved in an axial direction of the screw shaft 124a by driving the motor 124c. Here, the movement of the nut 124b and the push unit 130 may be limited by a second distance detection sensor 125 located near one end of the screw shaft 124a. For example, the movement of the nut 124b and the push unit 130 may be stopped when the second distance detection sensor 125 detects that the nut 124b and the push unit 130 are located at a predetermined distance from the one end of the screw shaft 124a. In the process of movement as described above, the push unit 130 moves along the second guide groove 123, and the movement of the push unit 130 along the second guide groove 123 in the frontward direction of the main body unit 110 will be referred to as a secondary linear motion. Here, a time at which the secondary linear motion is completed may be after a time at which the primary linear motion is completed. For example, the secondary linear motion may be initiated in response to the completion of the primary linear motion.

Further, according to one embodiment of the invention, as a result of the secondary linear motion, the push unit 130 may move the tray 200 in the frontward direction of the main body unit 110 and push it off of the support member 122, so that the tray 200 is unloaded onto a target structure 300. Here, the target structure 300 may be a table, shelf, mobile robot, or the like, and the unloading may be referred to as loading when the target structure 300 is a mobile robot.

Specifically, the support unit 120 may comprise a stepped part 126 abutting a longitudinal end of the support member 122 (see FIGS. 2 and 4). As the push unit 130 performs the secondary linear motion to push the tab 210, 220 of the tray 200 off of the support member 122, an end of the tab 210, 220 facing the push unit 130 may be located above the stepped part 126 at the time of completion of the secondary linear motion. Here, the end of the tab 210, 220 may be located above the stepped part 126 without contacting the stepped part 126. That is, when the secondary linear motion of the push unit 130 is completed, the tray 200 may rest on the target structure 300 without contacting any component of the unloading assembly 100, so that the unloading of the tray 200 may be completed. According to the process of unloading the tray 200 onto the target structure 300, the tray 200 may be considered to be finally released from the support unit 120 by means of the stepped part 126.

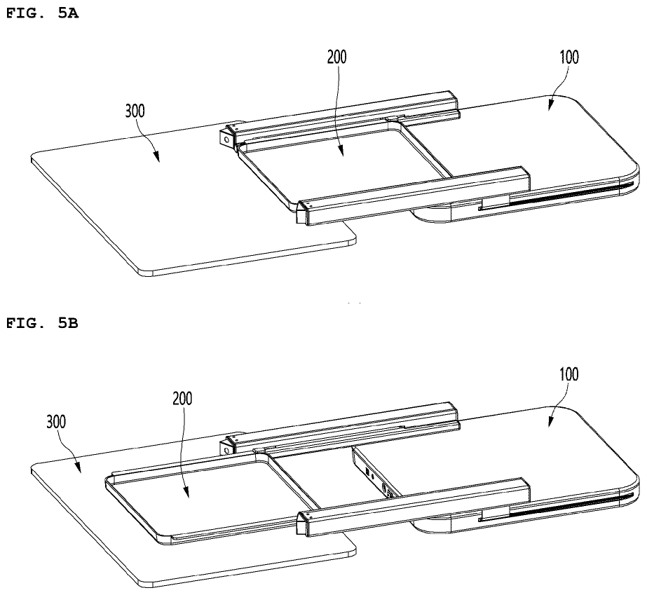

FIGS. 5A and 5B schematically show a process in which the unloading assembly 100 unloads the tray 200 onto the target structure 300 as described above. Specifically, FIG. 5A shows a time at which the primary linear motion of the unloading assembly 100 (specifically, the support unit 120) is completed, and FIG. 5B shows a time at which the secondary linear motion of the unloading assembly 100 (specifically, the push unit 130) is completed.

Meanwhile, in addition to the aforementioned components, the unloading assembly 100 according to one embodiment of the invention may have various internal or external components for assisting in its operation.

Specifically, according to one embodiment of the invention, a third distance detection sensor 114 may be provided on the front side of the main body unit 110 (see FIG. 2). The third distance detection sensor 114 may function to detect a distance between the unloading assembly 100 (specifically, the main body unit 110) and the target structure 300. For example, assuming that the unloading assembly 100 is disposed on a mobile robot and the mobile robot approaches the target structure 300, the unloading assembly 100 may utilize the distance detected by the third distance detection sensor 114 to cause the mobile robot to stop its operation in a position and posture for allowing the tray 200 to be unloaded onto the target structure 300. To this end, the unloading assembly 100 and the mobile robot may exchange control commands via a wired or wireless communication channel.

Further, according to one embodiment of the invention, an obstacle detection sensor 127 may be provided at a front end of the support unit 120 (see FIG. 2). The obstacle detection sensor 127 may function to detect an object (i.e., an obstacle) that is located on the top side of the target structure 300 and interferes with unloading the tray 200 onto the target structure 300. Here, the unloading assembly 100 may generate an alarm when an obstacle is detected by the obstacle detection sensor 127, and may cause the unloading operation to stop when the detected obstacle is not removed within a predetermined time.

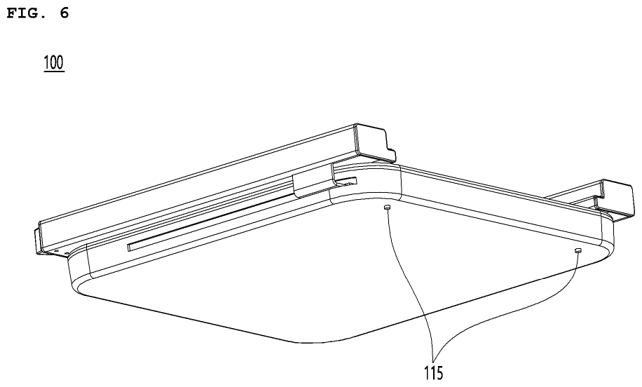

Furthermore, according to one embodiment of the invention, a tilt detection sensor 115 may be provided on the bottom side of the main body unit 110 (see FIG. 6). The tilt detection sensor 115 may function to detect whether the main body unit 110 is tilted in a predetermined situation. For example, the tilt detection sensor 115 may detect whether there is a change in a state in which the bottom side of the main body unit 110 contacts the side of a mobile robot or the like on which the main body unit 110 is disposed, during the primary or secondary linear motion. When a change in the above state (i.e., tilting of the main body unit 110) is detected by the tilt detection sensor 115, the unloading assembly 100 may cause the primary or secondary linear motion to stop.

In addition, according to one embodiment of the invention, at least one counterweight 116 may be provided within the main body unit 110 (see FIG. 3). The counterweight 116 may function to allow the unloading assembly 100 to be removably disposed, rather than fixedly coupled, at a predetermined position of a mobile robot, shelf, table, or the like. The number of the at least one counterweight 116 may be increased or decreased, and the number may be adjusted appropriately to prevent external forces from tilting the main body unit 110 or changing the position at which the main body unit 110 is placed.

Moreover, according to one embodiment of the invention, a power switch 117a for powering on/off the unloading assembly 100, a battery 117b for supplying power to the unloading assembly 100, a charging port 117c for charging the battery 117b, and a control unit 118 for controlling the overall operation of the unloading assembly 100 and communicating with an external device (e.g., a mobile robot) may be provided at appropriate positions of the main body unit 110, and various other components may be included in the unloading assembly 100.

### Operation Process of the Unloading Assembly

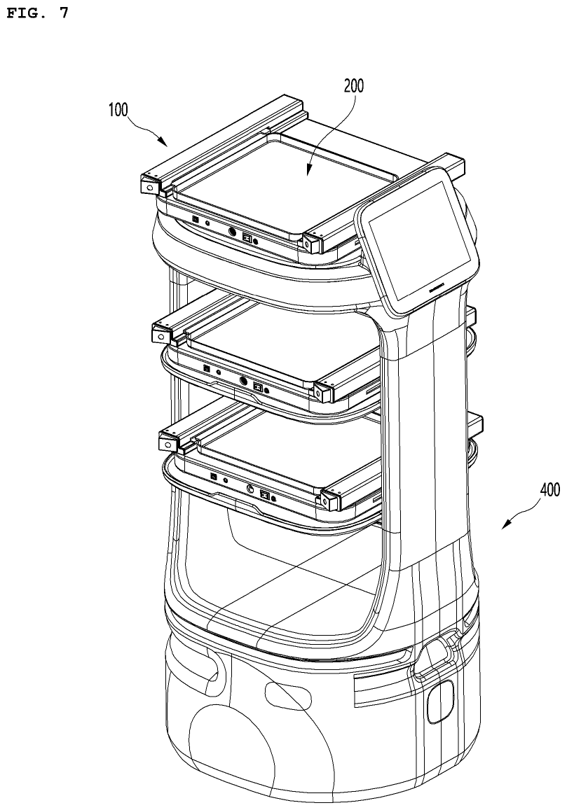

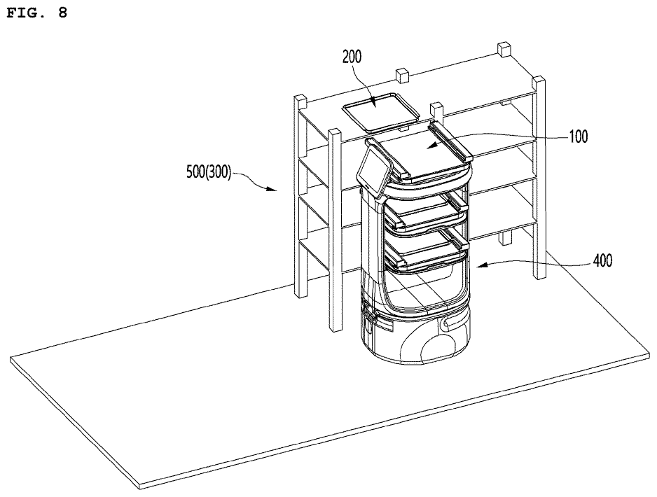

Hereinafter, the process in which the unloading assembly 100 unloads the tray 200 onto the target structure 300 will be discussed in detail, assuming that the unloading assembly 100 is disposed on a mobile robot 400 as shown in FIGS. 7 and 8. Here, the target structure 300 may be a fixed structure 500 such as a shelf or table.

First, when the power switch 117a of the unloading assembly 100 is switched from an off state to an on state, the battery 117b may supply power to the control unit 118, and the control unit 118 may perform a calibration operation on at least some of the components included in the unloading assembly 100. Here, the calibration operation may be intended to validate and verify whether at least some of the components included in the unloading assembly 100 are operated properly. For example, when the calibration operation is performed, the support unit 120 may perform one reciprocating motion in the axial direction of the screw shaft 112a of the first slide member 112, and the push unit 130 may perform one reciprocating motion in the axial direction of the screw shaft 124a of the second slide member 124.

Next, after the calibration operation is completed, the unloading assembly 100 (specifically, the control unit 118) may perform an operation for connecting a wired or wireless communication channel with the mobile robot 400. As the communication channel is connected between the unloading assembly 100 and the mobile robot 400, the unloading assembly 100 may exchange control commands with the mobile robot 400.

Next, as the mobile robot 400 approaches the target structure 300, the control unit 118 may cause the third distance detection sensor 114 to detect a distance between the main body unit 110 and the target structure 300. Here, the control unit 118 may cause the third distance detection sensor 114 to detect the distance between the main body unit 110 and the target structure 300 according to a control command from the mobile robot 400. The control unit 118 may determine whether the distance detected by the third distance detection sensor 114 corresponds to a reference distance (e.g., a distance that allows the stepped part 126 of the support unit 120 to be located above the target structure 300 at the time of completion of the primary linear motion). The control unit 118 may cause the mobile robot 400 to stop its operation in the current position and posture when it is determined that the distance detected by the third distance detection sensor 114 corresponds to the reference distance, and may cause the mobile robot 400 to adjust its position and posture when it is determined that the distance detected by the third distance detection sensor 114 does not correspond to the reference distance.

Next, the control unit 118 may cause the support unit 120 to initiate the primary linear motion in a state in which the operation of the mobile robot 400 is stopped as described above. Here, the control unit 118 may cause the obstacle detection sensor 127 to detect whether an obstacle is present on the top side of the target structure 300 (i.e., at the position where the tray 200 is to be unloaded) before the support unit 120 initiates the primary linear motion or while the support unit 120 performs the primary linear motion. The control unit 118 may generate an alarm when an obstacle is detected by the obstacle detection sensor 127. When the detected obstacle is not removed within a predetermined time, the control unit 118 may cause the support unit 120 to not initiate the primary linear motion or to stop the primary linear motion and return to its original position if the support unit 120 has already initiated the primary linear motion. Meanwhile, the tilt detection sensor 115 may detect whether the main body unit 110 is tilted while the support unit 120 performs the primary linear motion. When the tilt detection sensor 115 detects that the main body unit 110 is tilted, the control unit 118 may cause the support unit 120 to stop performing the primary linear motion and return to its original position.

Next, when the support unit 120 completes the primary linear motion, the control unit 118 may cause the push unit 130 to initiate the secondary linear motion at the time of completion of the primary linear motion. The push unit 130 may perform the secondary linear motion to push the tab 210, 220 of the tray 200 off of the support member 122, which causes the tray 200 to rest on the target structure 300, allowing the tray 200 to be unloaded onto the target structure 300. After the tray 200 is unloaded onto the target structure 300, the control unit 118 may return the support unit 120 and the push unit 130 to their original positions. FIG. 8 illustrates a situation in which, when the target structure 300 is a fixed structure 500 that is a shelf having multiple tiers, the unloading assembly 100 disposed on the mobile robot 400 unloads the tray 200 onto the top tier of the shelf and returns the support unit 120 and the push unit 130 to their original positions according to the above-described unloading process.

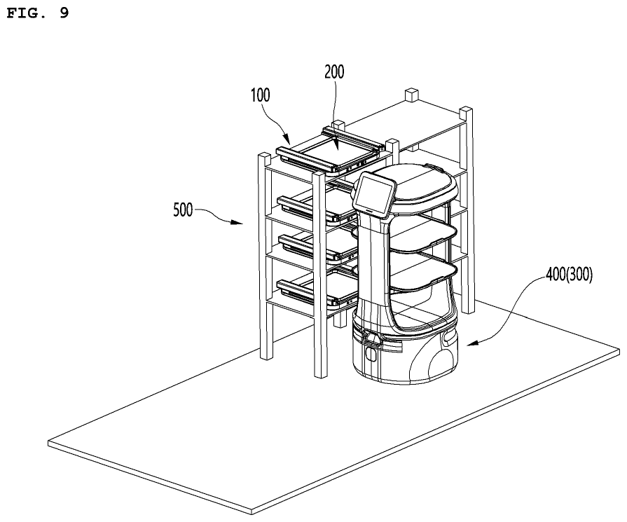

Meanwhile, as shown in FIG. 9, the unloading assembly 100 may be disposed on the fixed structure 500 rather than the mobile robot 400. In this case, the mobile robot 400 may be the target structure 300. That is, the unloading assembly 100 may not only unload the tray 200 from the mobile robot 400 to the fixed structure 500 (which is the target structure 300) as shown in FIG. 8, but also unload the tray 200 from the fixed structure 500 to the mobile robot 400 (which is the target structure 300) as shown in FIG. 9. As mentioned above, the unloading of the tray 200 from the fixed structure 500 to the mobile robot 400 may be referred to as loading. Meanwhile, since the process of unloading the tray 200 from the fixed structure 500 to the mobile robot 400 is similar to the process of unloading the tray 200 from the mobile robot 400 to the fixed structure 500, a detailed description thereof will be omitted.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

1. An unloading assembly for unloading a tray, comprising:
a main body unit having a left side and a right side on each of which a first guide groove is formed, and a bottom side removably attached to a predetermined position;
a support unit having a support member formed in an inward direction of the main body unit to support a tray, and configured to perform a primary linear motion along the first guide groove in a frontward direction of the main body unit, wherein a second guide groove is formed along at least a part of the support member; and
a push unit configured to perform a secondary linear motion along the second guide groove in the frontward direction of the main body unit to cause the tray to be unloaded onto a target structure.

2. The unloading assembly of claim 1, wherein the support unit is configured as a pair, and the pair of support units are disposed to face each other above a top side of the main body unit.

3. The unloading assembly of claim 1, wherein in a state in which the support member supports the tray, a top side of the main body unit and a bottom side of the tray are spaced apart by a predetermined distance.

4. The unloading assembly of claim 1, wherein a longitudinal direction of the second guide groove is parallel to a longitudinal direction of the first guide groove.

5. The unloading assembly of claim 1, wherein the secondary linear motion is initiated in response to completion of the primary linear motion.

6. The unloading assembly of claim 1, wherein the support unit comprises a stepped part abutting a longitudinal end of the support member, and the stepped part causes the tray to be released from the support unit when the secondary linear motion is completed.

7. The unloading assembly of claim 1, wherein the support unit comprises an obstacle detection sensor for detecting an obstacle located on a top side of the target structure.

8. The unloading assembly of claim 1, wherein the main body unit comprises a distance detection sensor for detecting a distance between the main body unit and the target structure.

9. The unloading assembly of claim 1, wherein the main body unit comprises a tilt detection sensor for detecting whether the main body unit is tilted during the primary or secondary linear motion.
